(19) United States
(12) Patent Application Publication
(10) Pub. No.: US 2008/0210838 A1
(43) Pub. Date: Sep. 4, 2008

(54) Carrier for Telescopic Poles

(76) Inventor: Eric Nielsen, Queensland (AU)

Correspondence Address: LADAS & PARRY, 5670 WILSHIRE BOULEVARD, SUITE 2100, LOS ANGELES, CA, 90036-5679, US

(21) Appl. No.: 11/997,398

(22) PCT Filed: Aug. 2, 2006
(86) PCT No.: PCT/AU2006/001093

§ 371 Date: Jan. 30, 2008

(30) Foreign Application Priority Data
Aug. 3, 2005 (AU) 2005904162

(51) Int. Cl. A47H 1/142; F16M 11/08

(52) U.S. Cl. 248/326; 248/689

(57) ABSTRACT

A carrier for a telescopic pole includes a support assembly that is fastenable to a vehicle. A displacement mechanism is arranged on the support assembly. A holder is pivotally mounted on the displacement mechanism and is engageable with the telescopic pole. The holder is pivotal between an operative position in which the telescopic pole is in a substantially upright position and an inoperative position in which the pole is in a prone position. The displacement mechanism is configured to displace the holder into a position spaced from the vehicle to facilitate pivotal movement of the pole between the substantially upright and prone positions.

### TECHNICAL FIELD

The present invention relates to a carrier for telescopic poles. The present invention has particular, although not exclusive, application to telescopic poles for cameras.

### BACKGROUND

Film crews or camera operators are frequently called out in their vehicles to sites where there is a major event underway. The vehicles contain camera and audio equipment which is used to record television coverage of the event. Invariably, large crowds and traffic jams may surround the event and hamper the vehicle from getting within close proximity to the actual event. In this case, the camera operator may not be able to film images of the event, may be obstructed by the crowd from getting a clear shot of the event, or may even miss filming important parts of the event when attempting to traverse through the crowd.

In other cases, the topography of the particular area where filming or photography is to take place may preclude conventional camera use. Still further, it may be desirable from an “effects” point of view to film or photograph from an elevated vantage point.

It is known to use telescopic poles with camera mounts to achieve the required effect or to address the problems associated with topography and crowds. However, these poles have to be properly secured to the ground with assemblies that can be complex and time-consuming to erect.

It is also known to use telescopic poles in combination with vehicles. However, Applicant has found these combinations are both unwieldy and cumbersome. They also require substantial modification to the vehicle in question, which is undesirable.

### SUMMARY OF THE INVENTION

According to a first aspect of the invention, there is provided a carrier for a telescopic pole, the carrier including:

a support assembly that is fastenable to a vehicle;

a displacement mechanism arranged on the support assembly; and

a holder that is pivotally mounted on the displacement mechanism and engageable with the telescopic pole, the holder being pivotal between an operative position in which the telescopic pole is in an upright position and a storage position in which the telescopic pole is in a prone position, the displacement mechanism being configured to displace the holder into a position spaced from the vehicle to facilitate pivotal movement of the pole between the substantially upright and prone positions.

The displacement mechanism may be configured to permit linear displacement of the holder into said spaced position. The displacement mechanism may include a fluidic ram assembly engageable with the support assembly and the holder to displace the holder into said spaced condition. Instead, the displacement mechanism may be configured to facilitate manual displacement of the holder into said spaced condition.

The support assembly may include a chassis that is fastenable to the vehicle. The displacement mechanism may include a trolley mounted on the chassis and displaceable with respect to the chassis. The fluidic ram assembly may include a sleeve that is fast with the chassis and a piston that is fast with the trolley. The fluidic ram assembly may be a pneumatic ram assembly,

The chassis may include a pair of parallel and opposed rails, the trolley including a plurality of rollers engaged with the rails to enable the trolley to move linearly with respect to the rails.

The chassis may include a vehicle roof mounting structure that is mountable on a roof of the vehicle and is configured to support the rails. The rails and the trolley may be oriented so that the trolley can be displaced into an operative position away from the roof of the vehicle and a storage position proximate the roof of the vehicle.

A locking arrangement may be engageable with the trolley and the chassis to lock the trolley in a releasable manner in either the operative or storage positions. Again, a locking arrangement may be provided to lock the swivel assembly with the telescopic pole in either the operative or prone positions.

The holder may include a clamp assembly for clamping a section of the telescopic pole.

In one embodiment, the carrier may be suited for use with a vehicle of the type having a sliding door, such a mini-bus type vehicle, such vehicles being popular in the field. The carrier may then include a fastening arrangement that is engageable with the base of the telescopic pole when the pole is in the operative position. The fastening arrangement may be configured to fasten, in a releasable manner, the base to an interior of the vehicle when the sliding door is open.

An example of a suitable fastening arrangement is one or more arms which are fastenable to a floor of the vehicle and engageable, in a releasable manner, with the base of the telescopic pole. An adjustable connecting assembly may be provided to permit a point of connection between the base and the arms to be adjusted.

According to a second aspect of the invention, there is provided a carrier for a telescopic pole, the carrier including:
a support assembly that is fastenable to a vehicle; and
a holder that is engageable with the telescopic pole and is pivotally arranged on the support assembly, the holder and support assembly being configured so that the holder and the telescopic pole can pivot between an operative position in which the telescopic pole is substantially upright and a storage position in which the telescopic pole is in a prone position.

According to a third aspect of the invention, there is provided a vehicle for carrying a telescopic pole, the vehicle including
a support assembly fast with a vehicle component;
a displacement mechanism arranged on the support assembly; and
a holder that is pivotally mounted on the displacement mechanism and engageable with a telescopic pole, the holder being pivotal between an operative position in which the telescopic pole is in an upright position and a storage position in which the telescopic pole is in a prone position, the displacement mechanism being configured to displace the holder into a position spaced from the vehicle to facilitate pivotal movement of the pole between the upright and prone positions.

According to a fourth aspect of the invention, there is provided a vehicle for carrying a telescopic pole, the vehicle including
a support assembly fast with a vehicle component; and
a holder that is engageable with the telescopic pole and is pivotally arranged on the support assembly, the holder and support assembly being configured so that the holder and the telescopic pole can pivot between an operative position in which the telescopic pole is upright and a storage position in which the telescopic pole is in a prone position.

According to a fifth aspect of the present invention, there is provided a telescopic pole assembly including:
a support assembly that is fastenable to a vehicle; and
a telescopic pole that is pivotally mounted to the support, the telescopic pole being pivotal between an operative, substantially upright position and a prone, storage position.

According to a sixth aspect of the invention, there is provided a carrier for a telescopic pole, the carrier including:
a support assembly that is fastenable to a vehicle; and
a displacement mechanism arranged on the support assembly, the displacement mechanism being engageable with the telescopic pole and being configured to displace the telescopic pole holder into a position to facilitate extension of the pole.

According to a seventh aspect of the invention, there is provided a vehicle for carrying a telescopic pole, the vehicle including
a support assembly that is fastenable to a component of the vehicle; and
a displacement mechanism arranged on the support assembly, the displacement mechanism being engageable with the telescopic pole and being configured to displace the telescopic pole holder into a position to facilitate extension of the pole.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a top perspective view of a first embodiment of a carrier, in accordance with the invention, for a telescopic pole, the view showing a support of the carrier fastened to the roof of a vehicle.

FIG. 2 is a bottom perspective view of the carrier of the first embodiment showing the carrier in a protracted position with the telescopic pole in an upright position.

FIG. 3 is a top perspective view of swivel and clamp assemblies for pivotally fastening the telescopic pole to a trolley in accordance with the first embodiment.

FIG. 4 is a top perspective view of a fastening arrangement of the carrier for fastening the base of the pole to a floor of the vehicle in accordance with the first embodiment.

FIG. 5 is a flowchart of a method for erecting a telescopic pole which is pivotally fastened to the vehicle in accordance with the first embodiment.

FIG. 6 is a top perspective view of a second embodiment of a carrier, in accordance with the invention, for a telescopic pole, the view showing a support assembly of the carrier fastened to the roof of a vehicle.

FIGS. 7A and 7B are, respectively, bottom and top perspective views of swivel and clamp assemblies for pivotally fastening the telescopic pole to a pneumatic ram of the carrier of FIG. 6.

FIGS. 8A and 8B are, respectively, a perspective view of an operative end of one form of telescopic pole that can be fastened to the carrier, and a camera and mount assembly suitable for mounting the operative end of the telescopic pole to said operative end of the telescopic pole.

FIG. 9 is a schematic view of a fastening arrangement of the carrier of FIG. 6 for fastening a base, of the telescopic pole to a floor of the vehicle.

### DETAILED DESCRIPTION OF PREFERRED EMBODIMENTS

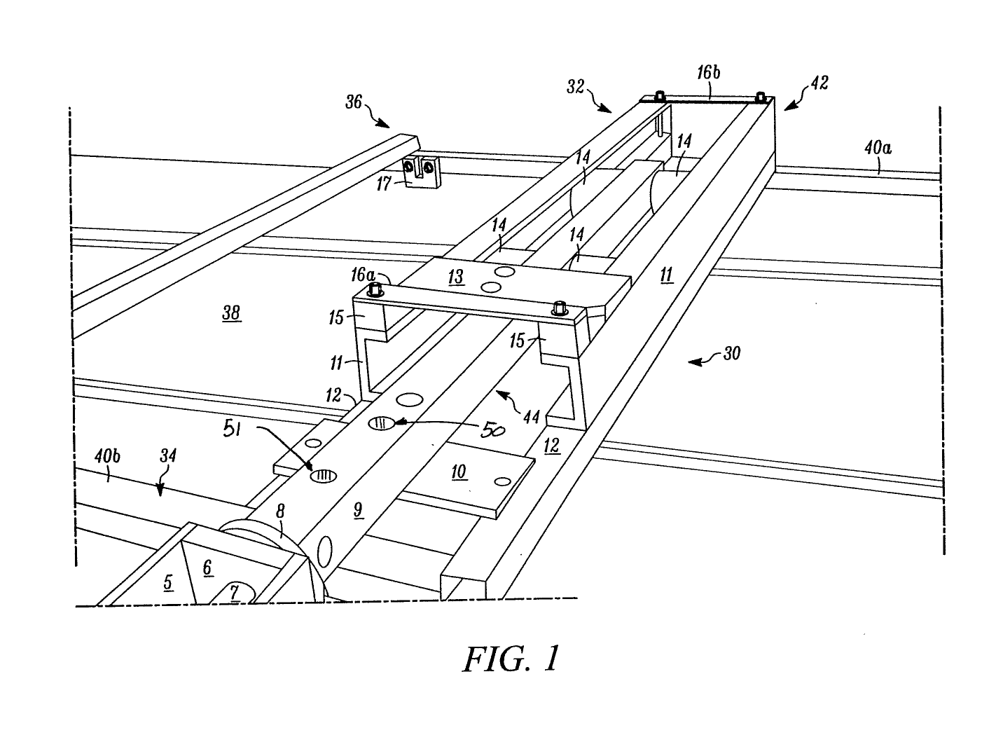

As shown in FIGS. 1 to 4, there is provided a carrier 30 for transporting and erecting a telescopic pole 2. In one example of an application, the carrier 30 may be secured to a vehicle and transported to a desired event. Once the vehicle is stationary, the camera is attached to the upper end of the pole 2, and the pole 2 is erected to thereby obtain aerial images of the event. It will however be appreciated that the carrier can have other uses, for example to film scenes otherwise obscured by topographical features, or to achieve a desired filming effect.

Referring to FIG. 1, the apparatus 30 includes a support assembly 32 that is fastenable to a roof 38 of the vehicle. The support assembly 32 includes a support structure 36 fastenable to the roof 38 and a chassis 42 fastenable to the support structure 36. A trolley 44 is mounted on the chassis 42 to be displaceable with respect to the chassis 42.

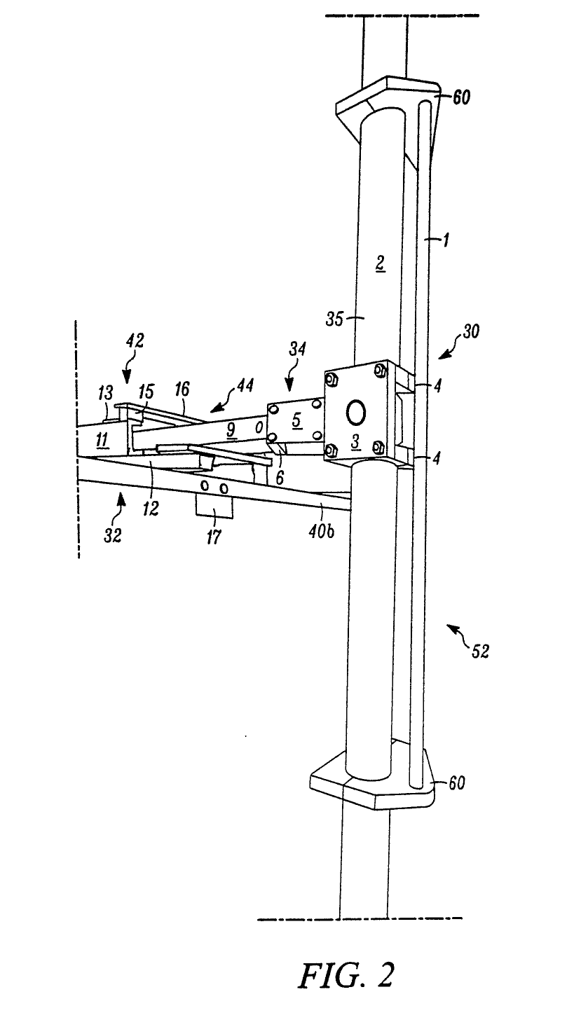

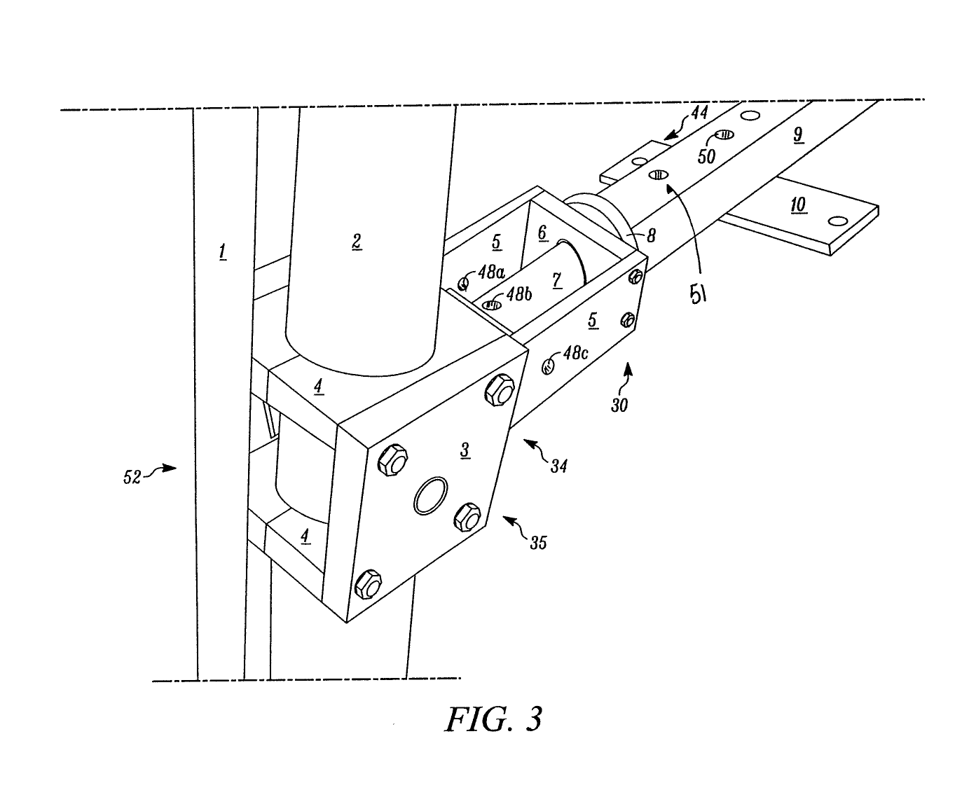

As can best be seen in FIGS. 2 and 3, the carrier 30 further includes a swivel assembly 34 which is fast with a protruding end of the trolley 44. A holder in the form of a clamp assembly 35 is mounted on the swivel assembly 34 and clamps on to the pole 2. Thus, the swivel assembly 34 serves pivotally to fasten the pole 2 to the trolley 44. In use, the trolley 44 can be protracted from the chassis 42 and the pole 2 can be pivoted into an upright position before being erected.

A detailed description of the structure and function of the carrier 30 is provided below.

Returning to FIG. 1, the support structure 36 includes a pair of opposed elements 40a, 40b which each extend along a side of the vehicle and are mounted to the roof 38 using a plurality of roof mounts 17.

The chassis 42 includes a trolley support frame 12 having a pair of elongate members which extend over the roof 38 from one side of the vehicle to the other. The elongate members are each firmly fixed to the elements 40a, 40b of the support structure 36. The chassis 42 further includes a pair of trolley rails 11 with a channeled profile, which are each fast with and supported by the trolley support frame 12.

The support assembly 32 further includes a pair of rail ties 16a, 16b which are fast with respect to respective ends of the trolley rails 11. The rail tie 16a proximate the swivel assembly 34 is mounted on a pair of travel stops 15.

The trolley 44 includes an elongate trolley arm 9 to which a quartet of rollers 14 are fastened. Each trolley rail 11 engages with a pair of the rollers 14 so that the trolley 44 can move along the trolley rails 11 between protracted and retracted positions. A travel stop plate 13 is mounted on the trolley arm 9 to bear against the travel stops 15 when the trolley arm 9 is displaced into the protracted position, to inhibit excessive movement.

Referring to FIGS. 2 and 3, the swivel assembly 34 is interposed between and fast with the protruding end of the trolley arm 9 and the clamp assembly 35. The swivel assembly 34 includes a swivel bar 7 and an adaptor 8 that are fixed to the trolley arm 9, and about which a pair of opposed pivot arms 5 and a pair of opposed bearing plates 6 can freely pivot. The clamp assembly 35 is fast with one of the plates 6 and includes a pair of clamp members, each including a pair of inner clamp shells 4 and an outer clamp plate 3 interposed between clamp shells 4 of respective pairs.

The swivel assembly 34 can be used to pivot the pole 2 between a prone position (i.e. during transportation), and an upright position when in use as shown in FIGS. 2 to 4.

As can best be seen in FIG. 3, the carrier 30 further includes a linear travel locking arrangement for locking the swivel assembly 34 against linear movement with respect to the support 32 when the pole 2 is in the operative position. The travel locking arrangement includes a travel lock plate 10 which is fastened to the trolley support frame 12. The travel lock plate 10 defines a locking aperture (not shown). The trolley arm 9 defines a complementary aperture 50. The aperture 50 is positioned so that, when the trolley arm 9 is in the protracted position, the apertures are aligned and a locking bolt can be received in the apertures to lock the trolley arm 9 with respect to the travel lock plate 10.

The carrier 30 also includes a swivel lock arranged on the swivel assembly 34. The swivel lock includes apertures 48a and 48c defined in respective pivot arms 5. A further, complementary aperture 48b is defined in the swivel bar 7. During locking, the trolley 44 is retracted into the chassis 42 and the pole 2 in its prone position so that locking apertures 48a, 48b, 48c are aligned. Also in the prone, retracted position, the aperture (not shown) defined in the travel lock plate 10 and a further aperture 51 in the trolley arm 9 are aligned. Respective locking rods (not shown) can pass through the apertures 48 and the through the aperture in the travel lock plate 10 and the aperture 51 to fix the pole 2 in the prone, retracted position.

Referring to FIG. 2, the carrier 30 further includes a handle 52 which is fixed to the pole 2 for facilitating movement of the trolley 44 between its protracted and retracted positions. The handle 52 includes a pipe bar 1 which is fixed to the pole 2 using a pair of opposed nylon handle mounts 60. The nylon handle mounts 60 are sized so that they abut the element 40b of the roof rack 36 when the trolley 44 is in its retracted position, and thereby support the weight of the pole 2 during transportation.

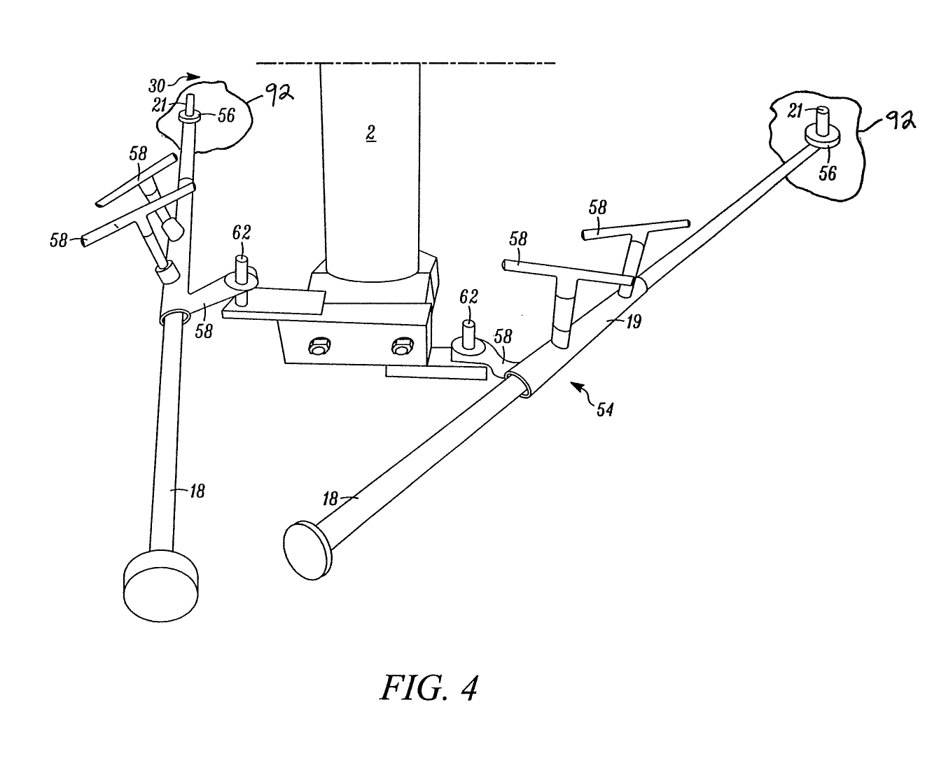

Referring to FIG. 4, the carrier 30 includes a fastening arrangement 54 for fastening the base of the pole 2 to the vehicle so as to maintain the pole 2 in its upright position. The fastening arrangement 54 includes a pair of leveling rods 18 which are each pivotally fastened to a respective fixing stud 21 protruding from a floor 92 of the vehicle. Each leveling rod 18 has a tie rod end 56 so that a degree of play is achieved between each leveling rod 18 and the respective fixing stud 21. The fastening arrangement 54 further includes a pair of sliding screw locks 19 which are each slidably mounted on a respective leveling rod 18. Each sliding screw lock 19 includes clamps 59 which engage, in a releasable manner, the leveling rods 18 so that a position of each lock 18 can be fixed relative to the respective leveling rod 18. A tie rod 58 extends from each lock 19 and engages a respective stud 62 extending from the base of the pole 2, with a degree of play. In use, the leveling rods 18 are substantially horizontal and limit the lateral movement of the base of the pole 2.

The vehicle is of a minibus type with a sliding door. Thus, when the door is open, the leveling rods 18 can extend from the floor of the vehicle to be fastened to the pole 2.

The apparatus 30 may further include a compressed air supply (not shown) which can be connected to the base of the telescopic pole 2. In use, the air supply can be activated so as to increase the pressure within the pole 2 and thereby cause the telescopic pole 2 to extend upwardly into the air. The pole 2 may be contracted by removing the compressed air supply from the pole 2 and releasing the pressure from within the pole 2.

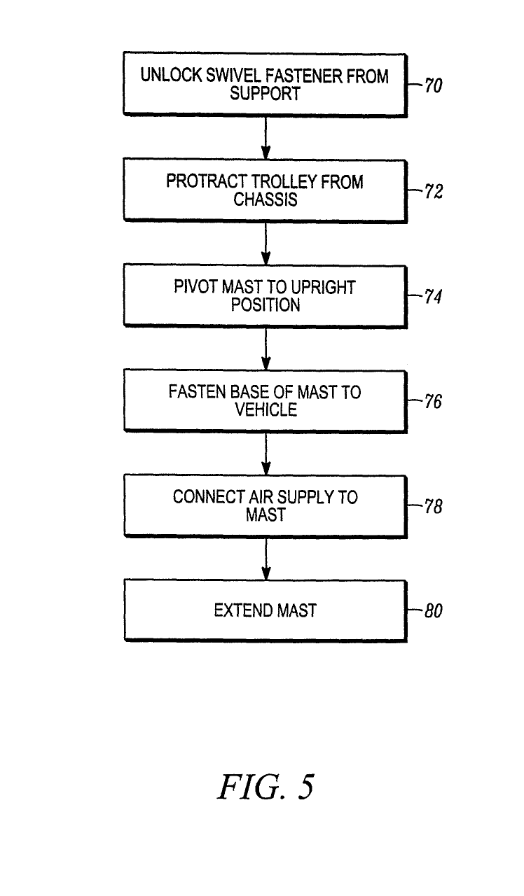

A method for erecting the extensible pole 2 will now be described with reference to the flowchart of FIG. 5.

Initially, the pole 2 is in a prone position with the travel lock enabled whereby the locking rod is located within locking apertures 48a, 48b, 48c and the aperture defined in the travel lock plate 10.

At step 70, the user unlocks the swivel assembly 34 by removing the locking rod from the pivot arms 5, swivel bar 7 and travel lock plate 10.

At step 72, the user pulls the handle 52 to slide the pole 2 away from the vehicle and protract the trolley 44 from the chassis 42. Alternatively, a pneumatic ram assembly described below can be used to protract the trolley 44 from the chassis 42.

At step 74, the user pivots the pole 2 to its upright position. The user then enables the trolley lock by placing the locking rod in the aperture 50 of the trolley arm 9 and the aperture in the travel lock plate 10, thereby firmly locking the trolley 44 with respect to the chassis 42.

At step 76, the user attaches the fastening arrangement 54 to the pole 2. At step 78, the user connects the pressurized air supply to the pole 2.

At step 80, the user enables the air supply so as to extend and erect the telescopic pole 2.

By following the foregoing steps, the user can quickly assemble and erect the pole 2. In addition, the pole 2 may be readily taken down and locked in a prone position on the vehicle by performing the reverse steps, thereby enabling the vehicle to be quickly moved to a new site for further filming.

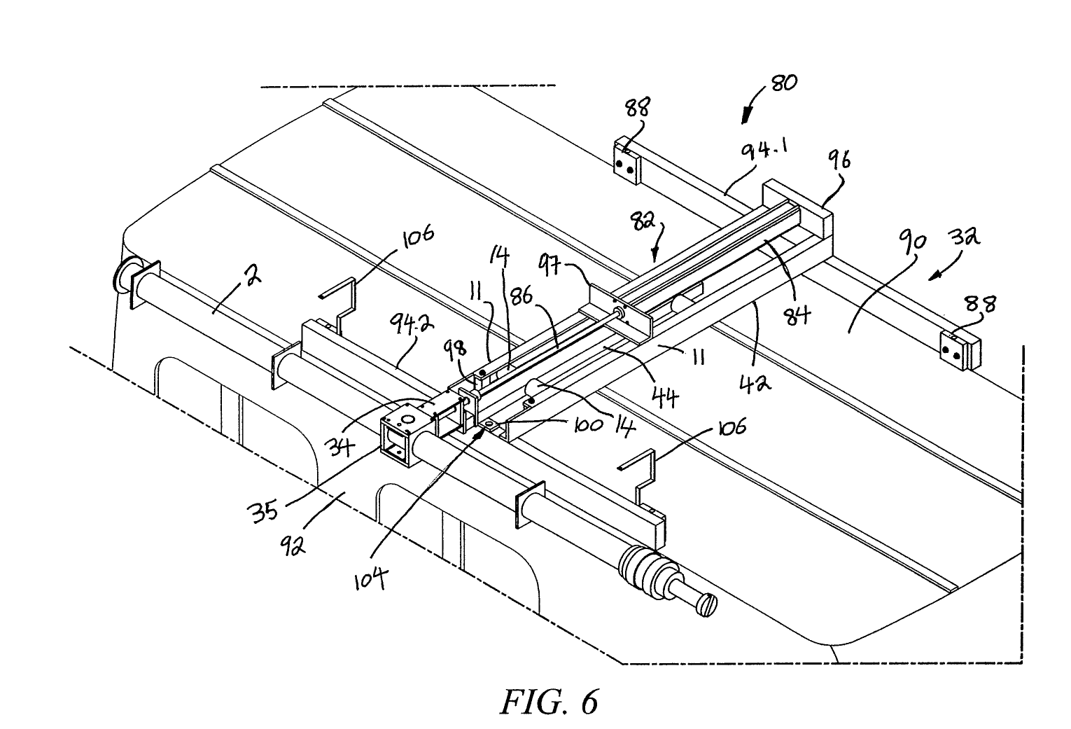

In FIG. 6, reference numeral 80 generally indicates a second embodiment of a carrier, in accordance with the invention, for telescopic poles. With reference to FIGS. 1 to 5, like reference numerals refer to like parts, unless otherwise specified.

The carrier 80 is configured so that a user need not manually displace the trolley 44 between the extended and retracted positions. Instead, the carrier 80 includes a pneumatic ram assembly 82 that is mounted between the chassis 42 and the swivel assembly 34. In particular, the ram assembly 82 includes a sleeve 84 fast with the chassis 42 and a piston 86 fast with the trolley 44, via a mounting plate 102.

The support assembly 32 includes two pairs of spaced roof mounts 88, each pair being mounted on a respective side of a roof 90 of a vehicle 92. The roof mounts 88 can be fastened to the roof 92 with under-roof plates (not shown) positioned under the roof 90 and engageable with the roof mounts 88 through the roof. A cross-bar 94 is fast with, and extends between the mounts 88 of respective pairs.

A back plate 96 is mounted on a distal cross bar 94.1. A distal end of the sleeve 84 is fast with the back plate 96.

A ram mount 97 is fast with and extends between the rails 11. A proximal end of the sleeve 84 is fast with the ram mount 97 and the piston 86 extends through the ram mount 97.

A stop block 98 is mounted in each rail 11 to inhibit excessive protraction of the piston 86 and thus the pole 2. A lock plate 100 is mounted on the trolley to register with a proximal cross bar 94.2. The lock plate 100 and cross bar 94.2 have corresponding openings 104 so that the trolley 44 can be locked to the proximal cross bar 94.2, in the protracted condition.

A pair of spaced clips 106 is mounted on the proximal cross bar 94.2. The clips 106 are shaped to engage and retain the pole 2 when the pole 2 is in the prone, inoperative position.

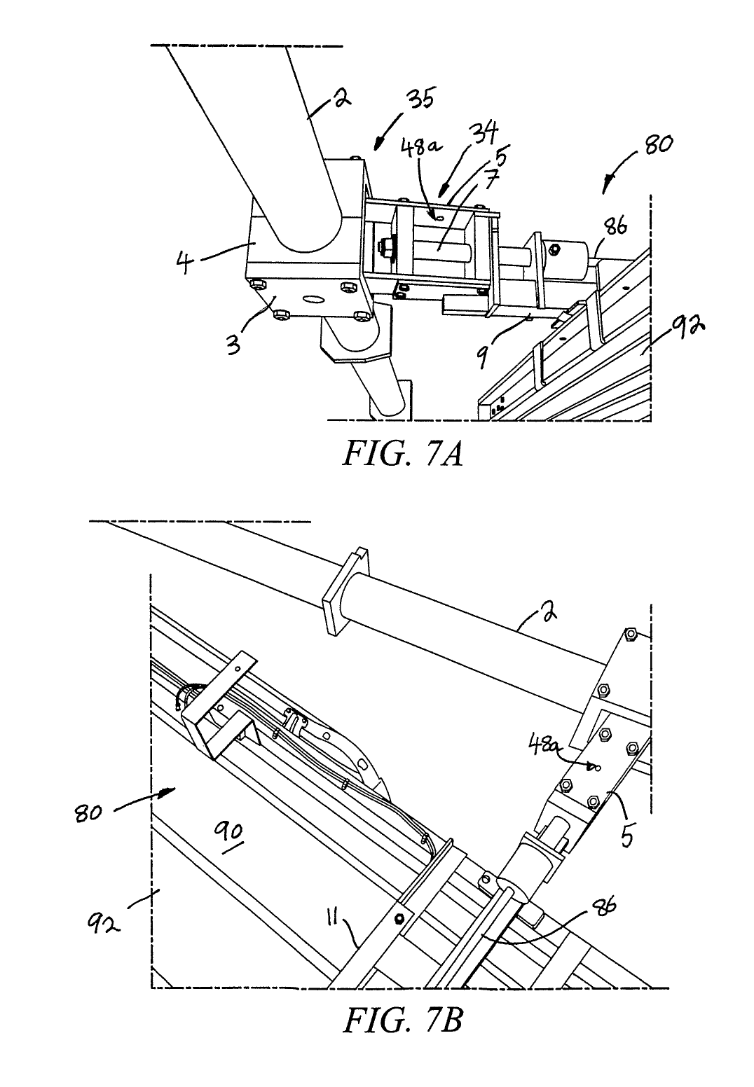

A conventional ram control arrangement and pressurized air supply (not shown) can be provided to operate the ram assembly 82. As can be seen in FIG. 7B, air hoses 108 extend from the pressurized air supply to the ram assembly 82 to operate the ram assembly 82.

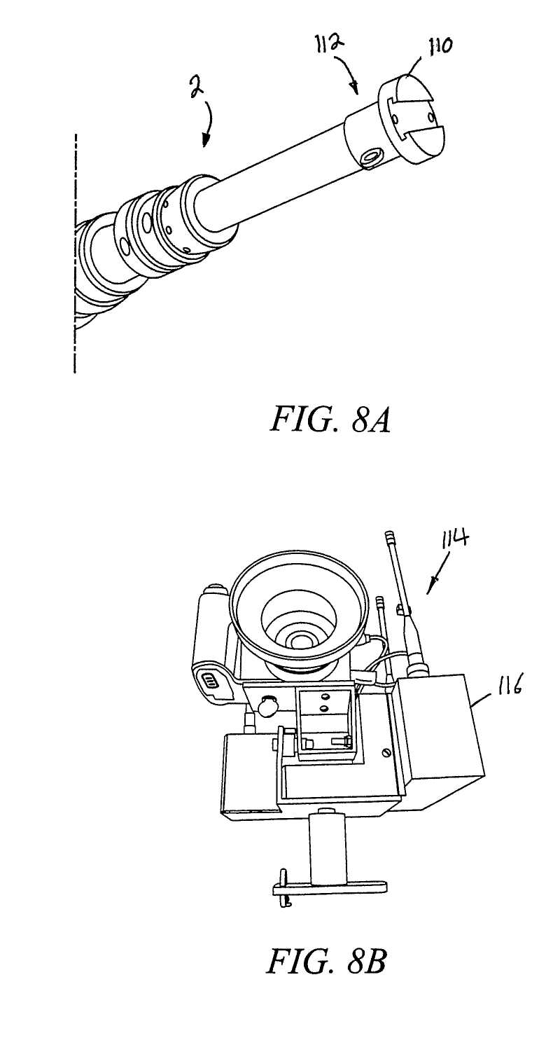

In FIG. 8A, a possible end configuration for the telescopic pole 2 is shown. A camera mount formation 110 is mounted on an operative end 112. In FIG. 8B, there is shown a camera and mount plate assembly 114 for mounting on the formation 110. A remote control module 118 is provided to permit remote operation of the camera.

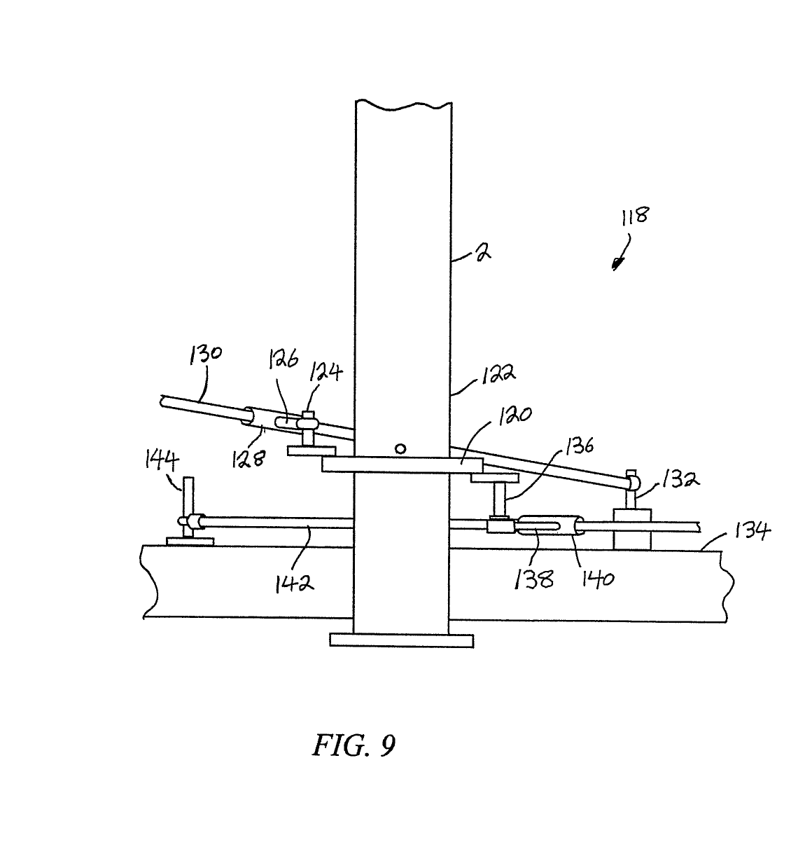

In FIG. 9, reference numeral 118 generally indicates an embodiment of a fastening arrangement for use with either of the carriers 30, 80. With reference to FIG. 4, like reference numerals refer to like parts, unless otherwise specified.

The arrangement 118 includes a mounting flange 120 fast with a base section 122 of the pole 2.

A first stud 124 is mounted on the flange 120 on a first side of the pole 2. A sleeve tie rod 126 is pivotally mounted on the first stud 124 and a sleeve 128 is fast with the tie rod 126. A first leveling rod 130 passes through the sleeve 128 and is pivotally fastened to a floor stud 132 positioned on a second, opposed side of the pole 2. The floor stud 132 is mounted on a floor 134 of the vehicle 92.

A second stud 136 is mounted on the flange 120 on said second side of the pole 2. A sleeve tie rod 138 is pivotally mounted on the second stud 136 and a sleeve 140 is fast with the tie rod 138. A second leveling rod 142 passes through the sleeve 140 and is pivotally fastened to a floor stud 144 positioned on the first side of the pole 2. The floor stud 144 is also mounted on the floor 134 of the vehicle 92.

As can be seen in FIG. 9, the leveling rods 130, 142 cross over behind the pole 2. This arrangement is useful for fastening the base section 122 to the floor 134, where the vehicle has a restricted door opening.

A person skilled in the art will appreciate that many embodiments and variations can be made without departing from the ambit of the present invention.

In both the first and second embodiments, the support 32 included a trolley 44 arranged on the chassis 42. In an alternative embodiment, an alternative type of carriage to the trolley may instead be used which does not include rollers. In one embodiment, the chassis may include bearings or the like to facilitate sliding of the trolley or carriage.

In one embodiment, the swivel assembly may be fixedly attached to the support to protrude from the vehicle. In this manner, the pole 2 need not be slid away from the vehicle before erection.

Still further, instead of the clamp assembly 35, the swivel assembly 34 can be connected to an integral, one-piece mounting formation arranged on the pole 2.

In yet another embodiment, the swivel assembly may be disposed of completely, with the trolley 44, or like apparatus being engaged with the pole to displace the pole towards and away from the vehicle.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A carrier for a telescopic pole, the carrier including:
a support assembly that is fastenable to a vehicle;
a displacement mechanism arranged on the support assembly; and
a holder that is pivotally mounted on the displacement mechanism and engageable with the telescopic pole, the holder being pivotal about an axis between an operative position in which the telescopic pole is in a substantially upright position and an inoperative position in which the pole is in a prone position, the displacement mechanism being configured to displace the holder along said axis into a position spaced from the vehicle to facilitate pivotal movement of the pole between the substantially upright and prone positions.

2. A carrier as claimed in claim 1, in which the displacement mechanism is configured to permit linear displacement of the holder into said spaced position.

3. A carrier as claimed in claim 2, in which the displacement mechanism includes a fluidic ram assembly engageable with the support assembly and the holder to displace the holder into said spaced position.

4. A carrier as claimed in claim 2, in which the displacement mechanism is configured to facilitate manual displacement of the holder into said spaced condition.

5. A carrier as claimed in claim 3, in which the support assembly includes a chassis that is fastenable to the vehicle, and the displacement mechanism includes a trolley mounted on the chassis and displaceable with respect to the chassis, the fluidic ram assembly including a sleeve that is fast with the chassis and a piston that is fast with the trolley.

6. A carrier as claimed in claim 5, in which the fluidic ram assembly is a pneumatic ram assembly,

7. A carrier as claimed in claim 4, in which the support assembly includes a chassis that is fastenable to the vehicle and the displacement mechanism includes a trolley mounted on the chassis and manually displaceable with respect to the chassis.

8. A carrier as claimed in claim 5 or 7, in which the chassis includes a pair of parallel and opposed rails, the trolley including a plurality of rollers engaged with the rails to enable the trolley to move linearly with respect to the rails.

9. A carrier as claimed in claim 8, in which the chassis includes a vehicle roof mounting structure that is mountable on a roof of the vehicle and is configured to support the rails.

10. A carrier as claimed in claim 8, in which the rails and the trolley are oriented so that the trolley can be displaced into an operative position away from the roof of the vehicle and a storage position proximate the roof of the vehicle.

11. A carrier as claimed in claim 5 or 7, which includes a locking arrangement engageable with the trolley and the chassis to lock the trolley in a releasable manner in either the operative or storage positions.

12. A carrier as claimed in claim 1, in which the holder includes a clamp assembly for clamping a section of the telescopic pole.

13. A carrier as claimed in claim 1, which includes a fastening arrangement fastenable to a floor of the vehicle and engageable, in a releasable manner, with a base of the telescopic pole.

14. A carrier for a telescopic pole, the carrier including:
a support assembly that is fastenable to a vehicle; and
a holder that is engageable with the telescopic pole and is pivotally arranged on the support assembly, the holder and support assembly being configured so that the holder and the telescopic pole can move along an axis and pivot about said axis between an operative position in which the telescopic pole is upright and a storage position in which the telescopic pole is in a prone position.

15. A vehicle for carrying a telescopic pole, the vehicle including
a support assembly fast with a vehicle component;
a displacement mechanism arranged on the support assembly; and
a holder that is pivotally mounted on the displacement mechanism and engageable with a telescopic pole, the holder being pivotal about an axis between an operative position in which the telescopic pole is in an upright position and a storage position in which the telescopic pole is in a prone position, the displacement mechanism being configured to displace the holder along said axis into a position to facilitate pivotal movement of the pole between the upright and prone positions.

16. A vehicle for carrying a telescopic pole, the vehicle including
a support assembly fast with a vehicle component; and
a holder that is engageable with the telescopic pole and is pivotally arranged on the support assembly, the holder and support assembly being configured so that the holder and the telescopic pole can move along an axis and pivot about said axis between an operative position in which the telescopic pole is upright and a storage position in which the telescopic pole is in a prone position.

17. A carrier for a telescopic pole, the carrier including:
a support assembly that is fastenable to a vehicle; and
a displacement mechanism arranged on the support assembly, the displacement mechanism being engageable with the telescopic pole and being configured so that the telescopic pole can move along an axis into a position to facilitate extension of the pole and can pivot about said axis.

18. A vehicle for carrying a telescopic pole, the vehicle including
a support assembly that is fastenable to a component of the vehicle; and
a displacement mechanism arranged on the support assembly, the displacement mechanism being engageable with the telescopic pole and being configured so that the telescopic pole can move along an axis into a position to facilitate extension of the pole and can pivot about said axis.

19. A telescopic pole assembly including:
a support assembly that is fastenable to a vehicle; and
a telescopic pole that is pivotally mounted to the support to pivot about an axis and is further arranged to move along said axis, the telescopic pole being pivotal between an operative, substantially upright position and a prone, storage position.
